(19) United States
(12) Patent Application Publication
(10) Pub. No.: US 2010/0045075 A1
(43) Pub. Date: Feb. 25, 2010

(54) FIXED TRANSPARENT MODULE ROOF FOR A MOTOR VEHICLE

(75) Inventors: Thomas Mack, Highland, MI (US); Chris Muller, Holly, MI (US); Jean-Guy Cocaign, Sable sur Sarthe (FR)

Correspondence Address: FITCH EVEN TABIN & FLANNERY, 120 SOUTH LASALLE STREET, SUITE 1600, CHICAGO, IL, 60603-3406, US

(73) Assignee: WEBASTO AG, Strockdorf (DD)

(21) Appl. No.: 12/194,781

(22) Filed: Aug. 20, 2008

(51) Int. Cl. B62D 25/06; B60J 10/00

(52) U.S. Cl. 296/215; 296/216.01; 296/223

(57) ABSTRACT

A fixed transparent module (FTM) for the roof of a vehicle having glass for cementing to the roof support surfaces to form a continuous seal; at least one compensation part running essentially parallel the roof support surface in a manner defining a space of substantially constant dimension between said outside surface of the compensation material and said roof support surface for receiving a cement layer of constant thickness; and at least one trim ring attached to said glass pane having a guide pin and attachment points, wherein said glass pane has added support, attachment points for additional features, and allowance for proper alignment of FTM to a vehicle body. Calibration stops can be added having a height that corresponds to the desired cement thickness of the cement layer. A reinforcement assembly, electric or manual sun shades can be added or, alternatively, the glass can be self darkening or use photoelectrochromic technology.

### FIELD OF THE INVENTION

The present invention generally relates to a glass panoramic roof for closing the opening of a vehicle and, more particularly, to a fixed glass roof that eliminates the need for a frame or trim panels.

### BACKGROUND OF INVENTION

Generally, the roof of a conventional vehicle is stamped sheet metal. It is known that a vehicle roof can also be at least partially made of a glass. Normally, in a vehicle configured as such, there is an opening in the roof that includes a support surface, which is designed to hold the peripheral edge of the glass pane in place.

Typically, the glass pane is cemented onto the support surface to become fixed to and part of the vehicle roof. A successful cementing operation would best include a uniform, continuous support surface that runs essentially and continuously parallel to the glass that is to be permanently connected. If there are faults or irregularities in the support surface, an unsatisfactory result, such as leaks, would likely occur. An attempt to cure such faults and irregularities may include the tendency to add cement, though this has often been known to fail.

Successful cementing of a glass panoramic roof panel to a vehicle having faults, irregularities, or an otherwise uneven support surface has been partially addressed by U.S. Pat. No. 6,913,310 to Albert. Albert discloses the use of a compensation part to fill irregularities to the support surface of a base sheet metal roof that is welded to the body and adapted with an opening for the panoramic roof. Albert also discloses the use of a calibration stop protruding from the compensation part and extending toward the support surface to assure an even and desired thickness of cement.

While these improvements mark a great advance in the art, further advances are possible. For example, a typical panoramic roof configuration is often more than just a pane of glass. It typically also has a frame, trim panels, tracks and the like, which must be accommodated in the environment and vehicle design specifications. It would be desirable in the art to discover ways to reduce the number of functional parts needed to provide a panoramic roof without compromising structural integrity.

### SUMMARY OF INVENTION

Accordingly, the present invention provides a fixed transparent module (FTM) adapted for placement on a vehicle designed to accept a prior art panoramic (or “pano”) roof having a frame. The present invention FTM allows for the elimination of the prior art frame and fills the void occupied by the frame with compensation parts. In doing so, the present FTM allows tremendous adjustment or adaptation to the various vehicles and conditions around the roof opening. Further, the present FTM appears to provide improved rigidity to the body over the prior art having a frame.

In one embodiment for the present invention, the FTM has at least one glass pane having an inner peripheral surface for cementing to the roof support surfaces to form a continuous seal; at least one compensation part having an inside surface attached to a glass pane and an outer surface attachable to an upper side of the roof support surface and which compensates for any faults, discontinuities, or irregularities in said peripheral support surface, the outer surface of the compensation part running essentially parallel to and being positioned relative to a corresponding section of the roof support surface in a manner defining a space of substantially constant dimension between said outside surface of the compensation material and said roof support surface for receiving a cement layer of constant thickness; and at least one trim ring attached to said glass pane having a guide pin and attachment points, wherein said glass pane has added support, attachment points for additional features, and allowance for proper alignment of FTM to a vehicle body.

Additional features that can be added to the invention include at least one calibration stop on the compensation part's outer surface, having a height that corresponds to the desired cement thickness of the cement layer. The calibration stops can be spaced along each compensation part at uniform intervals.

Additional embodiments can vary the number of panes of glass and the amount of fritted glass. Also, a reinforcement assembly can be added to add structural integrity to the vehicle.

Sun shades, and even electric or manual drives, can be added to the trim rings. Alternatively, the glass can be self darkening or even use photoelectrochromic technology.

Other features of the present invention will become more apparent to persons having ordinary skill in the art to which the present invention pertains from the following description and claims.

### BRIEF DESCRIPTION OF THE FIGURES

The foregoing features, as well as other features, will become apparent with reference to the description and figure below, in which like numerals represent elements and in which:

FIG. 1 is a rearward-facing bottom perspective view of one embodiment of the fixed transparent module of the present invention with detail.

FIG. 2 is an exploded rearward-facing top perspective view of one embodiment of the fixed transparent module of the present invention.

FIG. 3 is a rearward-facing perspective bottom view of one embodiment of a fixed transparent module of the present invention showing the compensation parts.

FIG. 4 is a forward-facing top perspective view of one embodiment of the fixed transparent module of the present invention.

FIG. 5 is a bottom view of one embodiment of the fixed transparent module of the present invention with added detail.

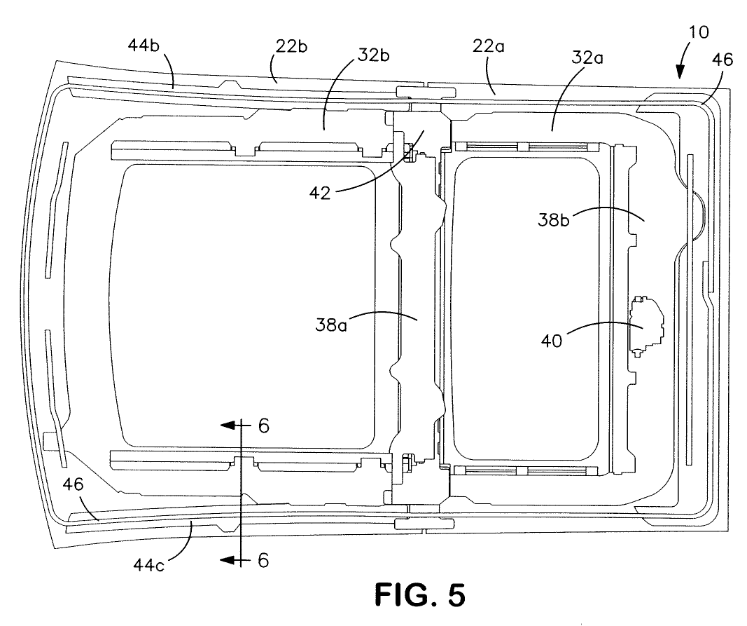

FIG. 6 is a rearward-facing cross-section taken on line 6-6 of FIG. 5 of one embodiment of the fixed transparent module of the present invention with added detail.

### DETAILED DESCRIPTION OF THE INVENTION

The present invention provides a fixed transparent module (FTM) adapted for placement on a vehicle designed to accept a prior art panoramic (or “pano”) roof having a frame. The present invention FTM allows for the elimination of the prior art frame and fills the void occupied by the frame with compensation parts. In doing so, the present FTM allows tremendous adjustment or adaptation to the various vehicles and conditions around the roof opening. Further, the present FTM appears to provide improved rigidity to the body over the prior art having a frame. The present FTM can be executed in a single transparent panel or, as illustrated, in multiple transparent panels. Transparent panels can be made from glass, polycarbonate, or other transparent materials known in the art that can be form into panels for a vehicle roof using sound engineering practices. Also, movable transparent panels could be configured to utilize some or all of the features of the present invention.

The compensation parts can also provide alignment points of the FTM unit on the vehicle, as well during installation. Other advantages of the present FTM over the prior art are reduced cost and weight by way of elimination of the frame, greater potential for a larger visible opening, greater accuracy in appearance of the finished vehicle, and a full glass appearance for the vehicle.

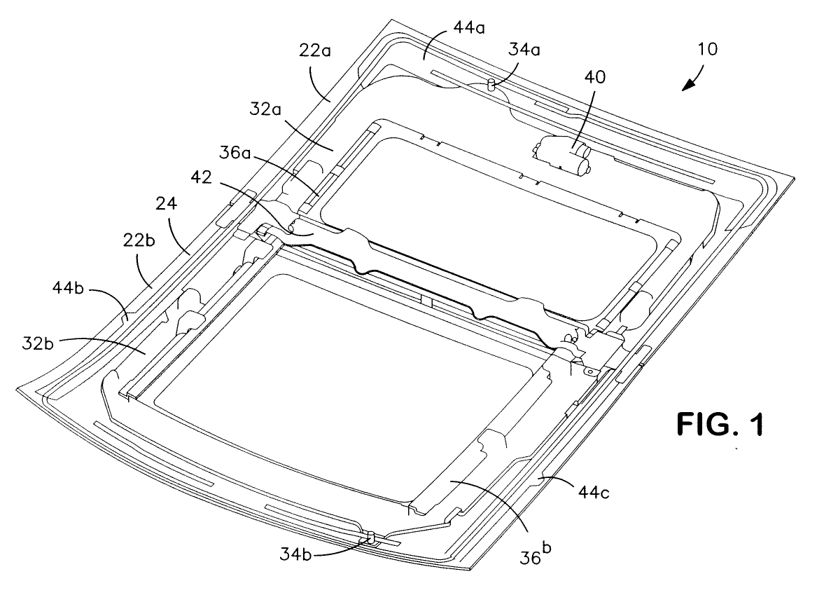

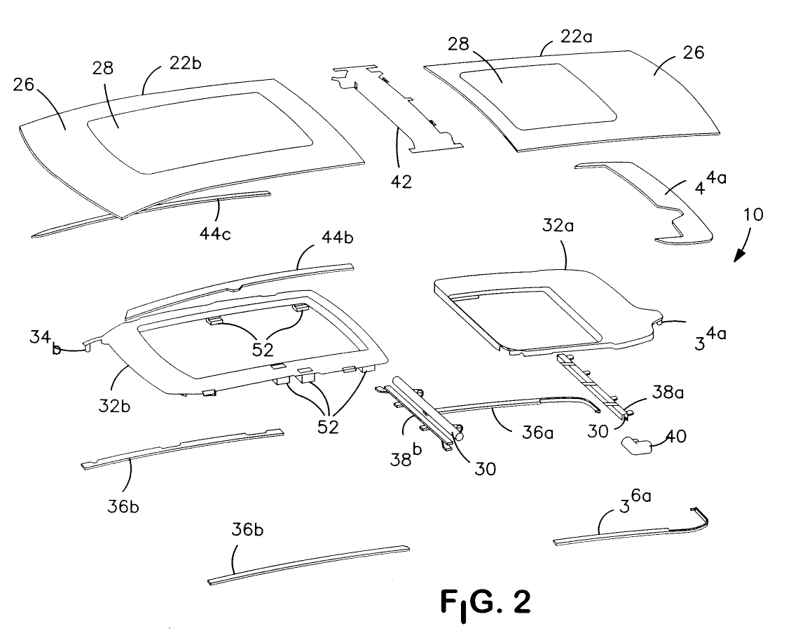

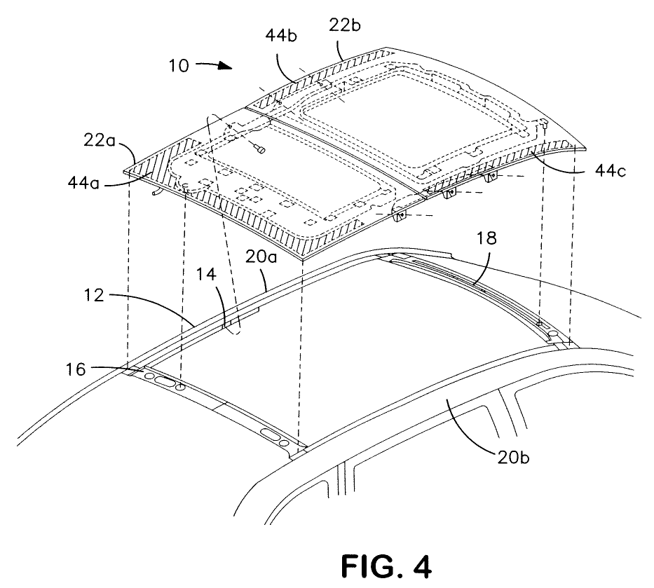

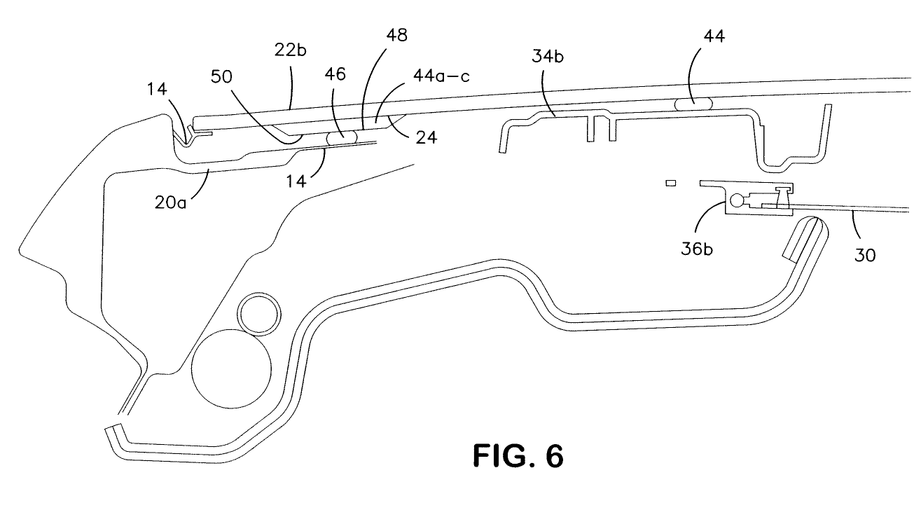

Turning now to the figures, FIGS. 1 and 2 illustrate component parts of one embodiment of the present invention fixed transparent module, which is generally indicated at 10. FTM 10 is designed to close an opening 12 (FIG. 4) provided in a vehicle roof. Opening 12 is bordered, in a conventional manner, by a support surface 14 (FIG. 4) configured to accept a pano roof module. Specifically, opening 12 generally extends in the transverse direction between the sides of the body and in the lengthwise direction, between a front roof element 18, which separates the roof from the windshield, and a rear roof element 16, which separates the roof from the back windshield. Side roof elements 20a and 20b, front roof element 18, and rear roof element 16 can each have an individual peripheral support surfaces on edges facing opening 12. The combination of these four individual roof elements form support surface 14 for the peripheral edge (two peripheral edges are shown in FIG. 6) of a transparent pane with a fixed connection, which is ordinarily formed by means of cementing or other means known in the art using sound engineering practices to form a seal. For example, a urethane adhesive can be used as a means of cementing and sealing glass to various surfaces.

FTM 10 can have at least one transparent pane. As stated above, transparent panes/panels can be made from glass, polycarbonate, or other transparent materials known in the art that can be form into panels for a vehicle roof using sound engineering practices. Two panes are illustrated and indicated as 22a (rearward) and 22b (forward), although it is noted that a single or multiple other configurations are possible using sound engineering practices and economics in manufacturing. For example, two smaller panes may be more cost efficient to manufacture and ship compared to one large single pane. Panes 22 have an inner peripheral surface 24, which can be cemented to an indicated support surface. The peripheral surface 24 here is defined as any surface located on the edge and on the inside of transparent planes 22.

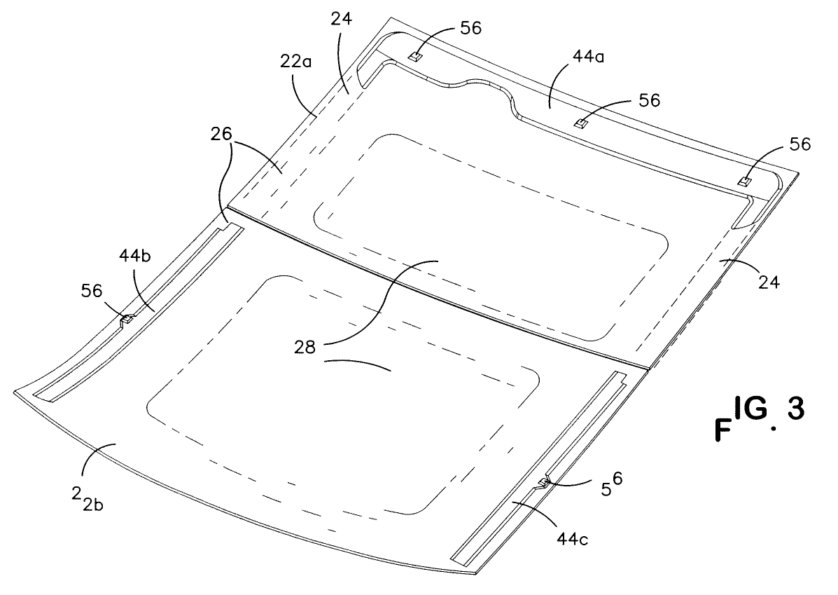

Transparent panes 22 can be “fritted” glass, which is tempered glass with a ceramic-based paint permanently bonded onto the glass during the tempering process. This edge ceramic “frit” prevents UV rays from penetrating the glass and is commonly used to prevent degrading the bonding sealant. As illustrated in FIG. 3, transparent panes 22 have a frifted area 26 and an un-fritted (i.e., daylight opening) area 28. Where a polycarbonate is used for the transparent pane 22, dual colored panes, one clear, one darkened, can also be used to give the effect of fritted glass. Transparent panes 22 can also be provided with a darkening devices 30 (sun shades), which can be deployed parallel to the inside surface of the transparent pane, especially to limit the greenhouse effect in the vehicle on days with strong incident solar radiation. The darkening device in this case is directly connected securely to the inside of the transparent panes 22 so that a genuine, complete module ready for installation results. Other types of darkening devices are known in the art and can include self darkening glass or even glass using photoelectrochromic technology.

FTM 10 can also include several other components, as illustrated. For example, as shown, FTM 10 can have attached to transparent panes 22a and 22b trim rings 32a and 32b respectively. Trim rings can be applied to panes 20 by cement (at 60, FIG. 6) or other means known in the art and can be used to add support and attachment points to other items, such as sun shade brackets 38a and 38b, sun shade tracks 36a and 36b, headliner attachment brackets 52, and an electric drive 40 for a sunshade. Manual drives as well as other types of vehicle interface attachments (not shown) are also possible. Trim rings can be configured to include guide pins 34a and 34b to allow proper alignment of FTM 10 to a vehicle body. It is noted that in an FTM 10 embodiment without trim rings, that guide pins, if any, can be bonded directly to the transparent surface.

FTM 10 can also add structural support to a vehicle by including a reinforcement assembly 42. Reinforcement assembly 42 can be made of steel or other material that can add structural integrity to a vehicle. Reinforcement assembly 42 can be attached to transparent panels 22 and also attached to a vehicle structural point. As shown, reinforcement assembly is attached to the side of the roof of the vehicle and provides lateral structural support.

According to the present invention, FTM 10 does not need to have a separate frame or other trim pieces usually associated with a typical glass roof assembly, including panoramic roofs. Nonetheless, several vehicles have been developed to receive a panoramic roof and have allowed space to accommodate its frame and/or trim panels. The current invention allows installation of the FTM 10 in these types of vehicles by providing compensation parts indicated at 44a-c. Compensation parts 44 can be pre-cemented or molded in place to transparent pane inner peripheral surface 24 and are shaped to accommodate the voids left by the absence of the frame. As such, each compensation part 44 can have a shape that corresponds essentially to the space that separates transparent pane inner peripheral surface 24 on the one hand, and the support surface coated with a constant and adequate cement layer from one another on the other (for example as shown at 46, FIG. 6), when the relative arrangement of the indicated inner peripheral surface 24 and the indicated support surface is optimum.

Thus, each compensation part 44 can be essentially complementary to a corresponding section of the support surface 14 (FIG. 6) and or/roof element 16, 18, and 20a-b, so that it forms an ideal intermediate element for connection of these two elements which almost never complement one another in practice, especially when structures such as a frame are removed. Furthermore, it goes without saying that uniformity and continuity of the cement layer (such as 46 below) constitute essential criteria for faultless cementing.

Compensation parts 44 can be made of a variety of materials known in the art and consistent with sound engineering practices. In one embodiment, compensation parts 44 are made of a polyurethane and cemented in place using a urethane cement (such as 46) on its inner surface and cemented to side roof elements 16, 18, and 20 on its outer surface 48. Compensation part 44 thus allows equalization of any deviation in parallelism and/or in the distance between transparent pane inner peripheral surface 24 and support surface 14. Cementing can thus be advantageously produced with a constant cement thickness to achieve a fixed connection and optimum tightness.

Compensation parts 44 can also be configured to add in calibration stops 56 as can be seen in FIG. 3. The height of calibration stops 56 correspond to a desired cement thickness. The free end of each calibration stop 56 is thus designed to come into contact with an upper side of the support surface and/or vehicle roof element (e.g., 16, 18, 20a-b). The presence of these projecting calibration stops 56 thus enables positioning of the transparent panes 22 relative to the support surface at a certain relative distance which corresponds to the desired cement thickness. It is especially advantageous that, along each compensation part 44, there are calibration stops 56 at regular intervals.

While the invention has been described in conjunction with specific embodiments, it is evident that many alternatives, modifications, and variations will be apparent to those skilled in the art in light of the foregoing description. Accordingly, the present invention attempts to embrace all such alternatives, modifications, and variations that fall within the spirit and scope of the appended claims.

What is claimed is:

1. A fixed transparent module (FTM) for placement on a vehicle having a roof opening and a peripheral support surface corresponding to accept the FTM, comprising:
at least one transparent pane having an inner peripheral surface for cementing to the roof support surfaces to form a continuous seal;
at least one compensation part having an inside surface attached to a transparent pane and an outer surface attachable to an upper side of the roof support surface and which compensates for any faults, discontinuities, or irregularities in said peripheral support surface, the outer surface of the compensation part running essentially parallel to and being positioned relative to a corresponding section of the roof support surface in a manner defining a space of substantially constant dimension between said outside surface of the compensation material and said roof support surface for receiving a cement layer of constant thickness; and
at least one trim ring attached to said transparent pane, wherein said transparent pane has added support and attachment points for additional features.

2. The FTM of claim 1, wherein said trim ring further comprises at least one guide pin to guide proper alignment of the FTM to a vehicle body.

3. The FTM of claim 1, wherein each compensation part has at least one calibration stop on its outer surface having a height that corresponds to the desired cement thickness of the cement layer.

4. The FTM of claim 3, wherein said calibration stops are spaced along each compensation part at uniform intervals.

5. The FTM of claim 1, wherein there are two transparent panes.

6. The FTM of claim 1, wherein said glass panes have at least partial fritted surfaces.

7. The FTM of claim 1, wherein said glass panes further comprise a shading device attached to said trim ring.

8. The FTM of claim 7, further comprising a drive attached to said trim ring and configured to drive the shading device between an open and closed position.

9. The FTM of claim 1, wherein said at least one glass pane is self darkening.

10. The FTM of claim 1, wherein said at least one glass pane is photoelectrochromic.

11. The FTM of claim 1, further comprising a reinforcement assembly attached to said at least one trim ring and configured to attach to the vehicle.

12. A fixed transparent module (FTM) for placement on a vehicle having a roof opening and a peripheral support surface corresponding to accept the FTM, comprising:
at least one transparent pane having an inner peripheral surface for cementing to the roof support surfaces to form a continuous seal;
at least one compensation part having an inside surface attached to a transparent pane and an outer surface attachable to an upper side of the roof support surface and which compensates for any faults, discontinuities, or irregularities in said peripheral support surface, the outer surface of the compensation part running essentially parallel to and being positioned relative to a corresponding section of the roof support surface in a manner defining a space of substantially constant dimension between said outside surface of the compensation material and said roof support surface for receiving a cement layer of constant thickness; and
at least one guide pin boned to said transparent pane to guide proper alignment of said FTM to a vehicle body.
